(19) United States
(12) Patent Application Publication
(10) Pub. No.: US 2007/0094499 A1
(43) Pub. Date: Apr. 26, 2007

(54) Processing device, authentication server, processing system and function offering method

(75) Inventor: Kenji Dokuni, Kyoto (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: MURATA KIKAI KABUSHIKI KAISHA, Kyoto-shi (JP)

(21) Appl. No.: 11/583,725

(22) Filed: Oct. 20, 2006

(30) Foreign Application Priority Data
Oct. 21, 2005 (JP) 2005-307367

(51) Int. Cl. H04L 9/00

(52) U.S. Cl. 713/168

(57) ABSTRACT

A digital MFP, which offers a function called by an operator, transmits a user ID and a password acquired from the operator to an authentication server and receives an authentication result with respect to the transmitted user ID and the password from the authentication server. The digital MFP receives a permission setting, which is information associated with the successfully authenticated user ID and the password and relates to whether or not to permit to offer a function, from the authentication server, and stores the received permission setting in a RAM. The digital MFP determines whether or not to permit to offer the function after the authentication has succeeded in accordance with the permission setting stored in the RAM.

### BACKGROUND OF THE INVENTION

1. Field of the Invention

The present invention relates to a processing device, which offers a function called by an operator, a processing system including the processing device, and an authentication server.

2. Description of the Related Art

A processing device including a plurality of functions, such as a digital Multi Function Peripheral (MFP), offers a function called by an operator. For example, in a typical digital MFP, when a function switching key of an operation panel is operated, one of a copy function, a fax function, a scanner function and a printer function is called, and the called function becomes usable.

Meanwhile, in the processing device including a plurality of functions, there are cases in which a permitted function is desirably differed for each operator. For example, in the digital MFP, there are cases in which all of the copy function, the fax function, the scanner function and the printer function are desirably permitted to an operator X, while only the copy function is desirably permitted to an operator Y.

In response to such a demand, an authentication server stores a permission setting relating to whether or not to permit to offer a function. Each time when a function is called at a processing device, the processing device inquires the authentication server as to whether or not an offering of the function is permitted.

However, according to the conventional art, since the processing device inquires the authentication server as to whether or not the offering of the function is permitted each time when the function is called, a communication data volume between the processing device and the authentication server increases resulting in an increase of a processing load of the authentication server.

### SUMMARY OF THE INVENTION

In order to overcome the problems described above, preferred embodiments of the present invention reduce a communication data volume between a processing device and an authentication server, and reduce a processing load of the authentication server.

According to a preferred aspect of the present invention, a processing device offers a function called by an operator. The processing device includes an authentication acquiring unit, a permission setting receiving unit, a storage unit, and a determination unit. The authentication acquiring unit transmits authentication information acquired from the operator to a remote authentication server, and receives an authentication result with respect to the transmitted authentication information from the authentication server. The permission setting receiving unit receives a permission setting from the authentication server. Further, the permission setting is information which is associated with the successfully authenticated authentication information and relates to whether or not to permit an offering of a function. The storage unit stores the received permission setting. After the authentication succeeds, the determination unit determines whether or not to permit the offering of the function in accordance with the permission setting stored in the storage unit.

According to another preferred aspect of the present invention, an authentication server includes a storage unit, an authentication offering unit, and a permission setting transmitting unit. The storage unit associates and stores authentication information and a permission setting. Further, the permission setting is information relating to whether or not to permit an offering of a function after an authentication has succeeded in a remote processing device. The authentication offering unit receives the authentication information from the processing device, and transmits an authentication result with respect to the received authentication information to the processing device. The permission setting transmitting unit transmits the permission setting, which is associated with the successfully authenticated authentication information, to the processing device.

According to another preferred aspect of the present invention, the authentication server can select the permission setting associated with the authentication information from previously registered choices.

According to another preferred aspect of the present invention, the authentication server can assign an identification name to the choices, and refer to the assigned name when selecting from the choices.

According to another preferred aspect of the present invention, a processing system includes a processing device, which offers a function called by an operator, and an authentication server. The processing device includes an authentication acquiring unit, a permission setting receiving unit, a storage unit, and a determination unit. The authentication acquiring unit transmits authentication information acquired from the operator to the authentication server, and receives an authentication result with respect to the transmitted authentication information from the authentication server. The permission setting receiving unit receives a permission setting from the authentication server. Further, the permission setting is information which is associated with the successfully authenticated authentication information and relates to whether or not to permit an offering of a function. The storage unit stores the received permission setting. After the authentication succeeds, the determination unit determines whether or not to permit the offering of the function in accordance with the permission setting stored in the storage unit. The authentication server includes a storage unit, an authentication offering unit, and a permission setting transmitting unit. The storage unit associates and stores the authentication information and the permission setting. The authentication offering unit receives the authentication information from the processing device, and transmits an authentication result with respect to the received authentication information to the processing device. The permission setting transmitting unit transmits the permission setting, which is associated with the received authentication information, to the processing device.

According to the above-described preferred aspects, since the authentication result is not required to be acquired each time when a function is called, a communication data volume between the processing device and the authentication server can be reduced, and the processing load of the authentication server can be reduced.

According to the above-described preferred aspects, the permission setting can be edited easily.

Other features, elements, processes, steps, characteristics and advantages of the present invention will become more apparent from the following detailed description of preferred embodiments of the present invention with reference to the attached drawings.

### BRIEF DESCRIPTION OF THE DRAWINGS

FIG. 1 is a block diagram illustrating an overall configuration of an image processing system according to a preferred embodiment of the present invention.

FIG. 2 illustrates a communication protocol between a digital MFP and an authentication server when carrying out an authentication process and an option process.

FIG. 3 is a block diagram illustrating a configuration of the digital MFP.

FIG. 4 is a block diagram illustrating a configuration of the authentication server.

FIG. 5 is a flowchart illustrating an operation of the digital MFP and the authentication server relating to a determination of whether or not to permit an offering of a function.

FIG. 6 illustrates an example of record information.

FIG. 7 illustrates a permission setting editing screen used for editing a permission setting.

### DETAILED DESCRIPTION OF PREFERRED EMBODIMENTS

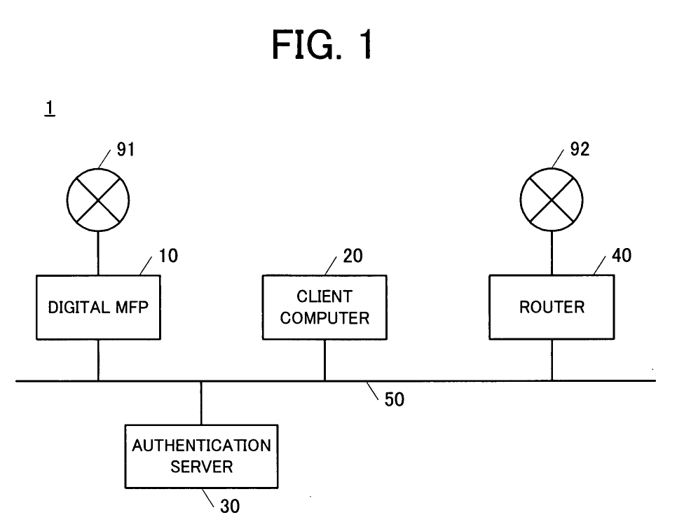

(1. Overall configuration of image processing system) FIG. 1 is a block diagram illustrating an overall configuration of an image processing system 1 according to a preferred embodiment of the present invention.

The image processing 1 includes a digital MFP 10, a client computer 20, and an authentication server 30.

The digital MFP 10, the client computer 20 and the authentication server 30 are connected to a Local Area Network (LAN) 50 to enable communication to be carried out between one another. The digital MFP 10 is also connected to a Public Switched Telephone Networks (PSTN) 91. The LAN 50 is connected to a remote network such as the Internet 92 via a network apparatus such as a router 40.

The digital MFP 10 includes a copy mode, a fax mode, a scanner mode and a printer mode. The digital MFP 10 serves as an image processing device that carries out an image processing.

The client computer 20 is generally a personal computer.

The authentication server 30 is a server computer that provides a directory service such as a Lightweight Directory Access Protocol (LDAP) service.

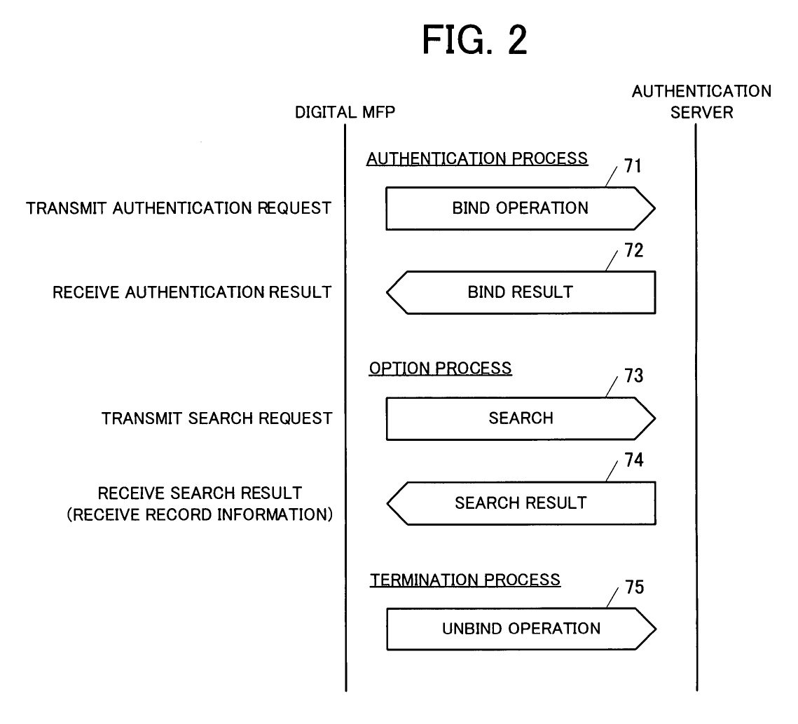

Provided that the authentication server 30 is an LDAP server, with reference to FIG. 2, a description will be made of a communication protocol between the digital MFP 10 and the authentication server 30 when carrying out an authentication process and an option process.

In case of an authentication process, first, a BIND operation 71 is carried out from the digital MFP 10 to the authentication server 30. In response to the BIND operation 71, the authentication server 30 returns a BIND result 72 to the digital MFP 10. In the BIND operation 71, the digital MFP 10 transmits a user ID and a password, i.e., authentication information, to the authentication server 30. When the user ID and the password are appropriate, the authentication server 30 returns “true” to the digital MFP 10 to permit binding of the digital MFP 10. When the user ID and the password are inappropriate, the authentication server 30 returns “false” to the digital MFP 10 not to permit the binding of the digital MFP 10. That is, the BIND operation 71 is an authentication request from the digital MFP 10 to the authentication server 30. The BIND result 72 (BIND permission/rejection) is an authentication result (authentication success/failure) with respect to the authentication request.

Following the authentication process, an additionally executable option process is executed between the digital MFP 10 and the authentication server 30. In the option process, the digital MFP 10 transmits a search request (SEARCH) 73 to the authentication server 30, and in response to the search request 73, the authentication server 30 returns a search result 74 including record information to the digital MFP 10. The option process may be executed only once or may be executed twice or more.

After the authentication process and the option process, an UNBIND operation 75 is carried out from the digital MFP 10 to the authentication server 30, and a series of communication protocol between the digital MFP 10 and the authentication server 30 ends.

The authentication server 30 can also carry out the authentication process and the option process with the client computer 20.

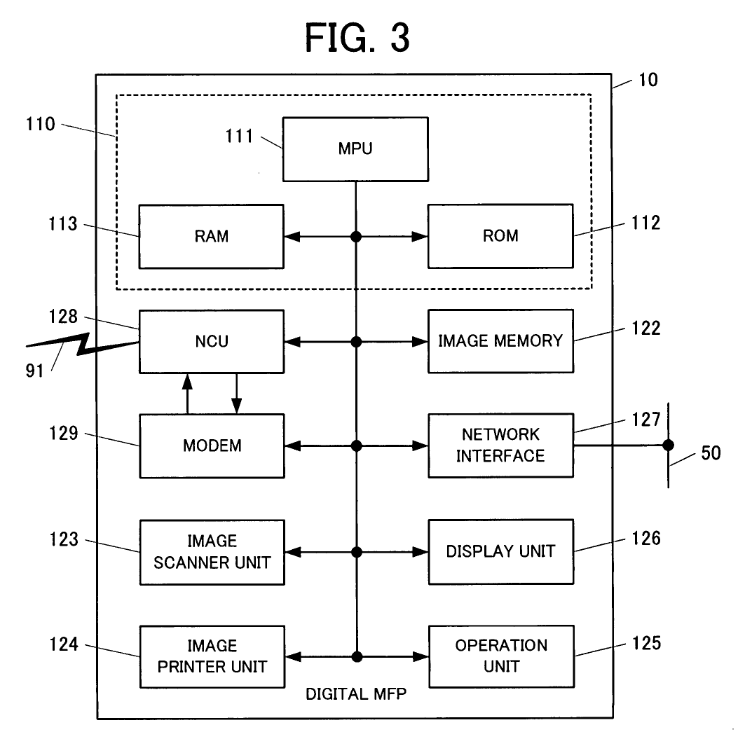

(2. Configuration of image processing device) FIG. 3 is a block diagram illustrating a configuration of the digital MFP 10 according to a preferred embodiment of the present invention.

As illustrated in FIG. 3, the digital MFP 10 includes a Micro Processor Unit (MPU) 111, a Read Only Memory (ROM) 112, and a Random Access Memory (RAM) 113. A microcomputer 110 is realized by the MPU 111, the ROM 112 and the RAM 113. The microcomputer 110 executes a program stored in the ROM 112 to control each component of the digital MFP 10, and realizes various functions of the digital MFP 10.

An image memory 122 of the digital MFP 10 stores image data of an image to be processed by the digital MFP 10.

The digital MFP 10 includes an image scanner unit 123 and an image printer unit 124. The image scanner unit 123 scans an image on an original document by a Charge Coupled Device (CCD) image sensor or the like, and generates image data relating to the scanned image. The image scanner unit 123 can scan an image on an original document by an Automatic Document Feeder (ADF) method or a Flat Bed Scanner (FBS) method. The image printer unit 124 forms an image relating to the image data on a printing medium by an electrophotographic method.

The digital MFP 10 includes an operation unit 125 and a display unit 126 as a user interface. The digital MFP 10 adopts a liquid crystal touch-screen display for the display unit 126. The display unit 126 partially functions as the operation unit 125. A copy function, a fax transmission function, a scanner function or a printer function may be called and used according to an operation performed on a function switching key of the operation unit 125 of the digital MFP 10.

A network interface 127 connects the digital MFP 10 and the LAN 50 by the Ethernet (registered trademark), for example.

A Network Control Unit (NCU) 128 and a Modulator Demodulator (MODEM) 129 are used for transmitting and receiving a fax image via the PSTN 91. The NCU 128 controls a connection established with the PSTN 91. The NCU 128 includes a function for transmitting a dial signal corresponding to a telephone number of a communication destination, and a function for detecting an incoming call. The MODEM 129 modulates transmission data and demodulates received data in accordance with V.17, V.27ter, V.29 or the like based on a facsimile transmission control protocol following the International Telecommunication Union-Telecommunications (ITU-T) recommendation T.30. Alternatively, the MODEM 129 modulates transmission data and demodulates received data in accordance with V.34.

Under the copy mode, the digital MFP 10 scans an image on an original document by the image scanner unit 123, and forms the image on a printing medium by the image printer unit 124. Accordingly, the image is copied from the original document to the printing medium (copy function).

Under the fax mode, the digital MFP 10 scans an image on the original document by the image scanning unit 123, and transmits the scanned image to another fax machine by the NCU 128 and the MODEM 129(fax transmission function). The digital MFP 10 forms an image transmitted from another fax machine on a printing medium by the image printer unit 124 (fax reception function). Further, the digital MFP 10 uses the G3 method or the super-G3 method for transmission and reception of fax using the PSTN 91.

Under the scanner mode, the digital MFP 10 scans an image on the original document by the image scanner unit 123, and stores the scanned image in a designated storage location (scanner function).

Under the printer mode, the digital MFP 10 receives an image transmitted from the client computer 20 via the LAN 50, and forms the image on a printing medium by the image printer unit 124 (printer function).

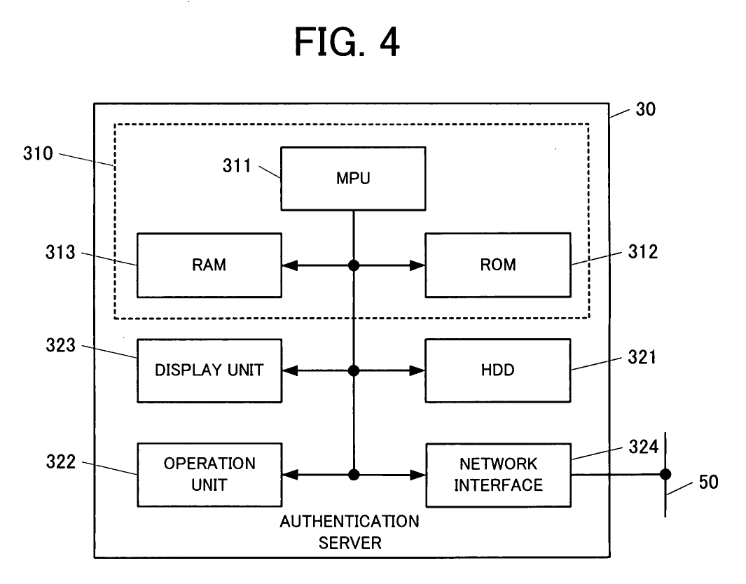

(3. Configuration of authentication server) FIG. 4 is a block diagram illustrating a configuration of the authentication server 30.

As illustrated in FIG. 4, the authentication server 30 includes an MPU 311, a ROM 312, and a RAM 313. The authentication server 30, which is a computer, executes a program stored in the ROM 312 to control each component of the authentication server 30 and realizes various functions of the authentication server 30.

A Hard Disk Drive (HDD) 321 of the authentication server 30 is a high-capacity auxiliary storage device.

The authentication server 30 includes an operation unit 322 and a display unit 323 as a user interface.

A network interface 324 connects the authentication server 30 to the LAN 50 by the Ethernet (registered trademark), for example.

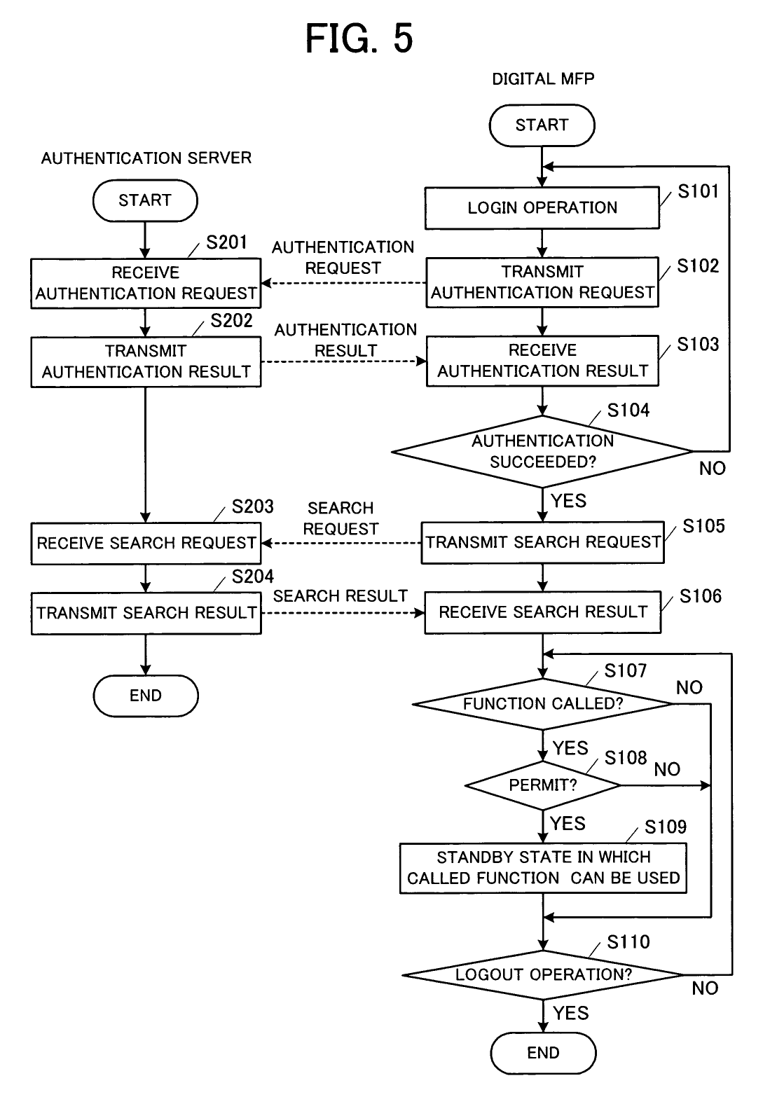

(4. Operation relating to determination of whether or not to permit an offering of a function) FIG. 5 is a flowchart illustrating an operation of the digital MFP 10 and the authentication server 30 relating to a determination as to whether or not to permit an offering of a function. The operation illustrated in FIG. 5 is carried out by executing the program stored in the ROM 112 by the microcomputer 110 and executing the program stored in the ROM 312 by the authentication server 30.

As illustrated in FIG. 5, when a login operation is performed on the digital MFP 10 (step S101), the digital MFP 10 transmits an authentication request to the authentication server 30 (step S102). The authentication request includes a user ID and a password acquired from the operator, i.e., a user ID and a password entered by the operator during the login operation.

The authentication server 30 receives the authentication request from the digital MFP 10 (step S201), and transmits an authentication result with respect to the received user ID and the password to the digital MFP 10 (step S202).

The digital MFP 10 receives the authentication result with respect to the transmitted user ID and the password from the authentication server 30 (step S103).

When the authentication with respect to the user ID and the password fails in the authentication process of steps S102 through S103 and S201 through S202 (step S104: NO), the process returns to step S101 and the login operation is performed again by the operator.

Meanwhile, when the authentication with respect to the user ID and the password succeeds in the authentication process (step S104: YES), the digital MFP 10 transmits a search request of a permission setting, which is associated with the successfully authenticated user ID, to the authentication server 30 (step S105).

Then, the authentication server 30 receives the search request from the digital MFP 10 (step S203), and transmits the permission setting of the search result to the digital MFP 10 (step S204). Accordingly, the authentication server 30 can transmit the permission setting to the digital MFP 10 in connection with the transmission of the authentication result.

Then, the digital MFP 10 receives the permission setting from the authentication server 30, and stores the received permission setting in the RAM 113 (step S106).

Further, the permission setting is information relating to whether or not to permit an offering of a function of the digital MFP 10, i.e., the copy function, the fax transmission function, the scanner function and the printer function, to the operator. The permission setting is extracted from the record information stored in the HDD 321.

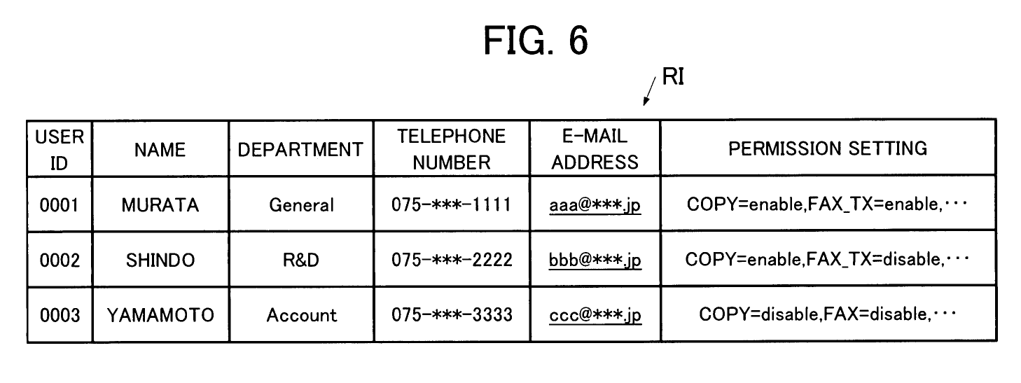

As illustrated in FIG. 6, the record information is information that associates a user ID of each operator with the permission setting. Further, the record information RI illustrated in FIG. 6 includes a name, a department, a telephone number, and an e-mail address in addition to the user ID and the permission setting. Other items may be added to the record information RI.

As illustrated in FIG. 6, the permission setting is described in a text format. Specifically, the permission setting includes information of permission (enable) or prohibition (disable) for each of the copy function (COPY), the fax transmission function (FAX_TX), the scanner function (SCAN), and the printer function (PRINT).

Alternatively, the permission setting may be designated by bit assign. That is, the permission setting may be described by a binary number, and each of the copy function (COPY), the fax transmission function (FAX_TX), the scanner function (SCAN) and the printer function (PRINT) may be assigned to each bit of a bit sequence. When the bit is “1”, it may be assumed that permission is set. When the bit is “0”, it may be assumed that prohibition is set.

When the permission setting is stored in the RAM 113 by the option process of steps S105 through S106 and S203 through S204, the digital MFP 10 refers to the permission setting and determines whether or not to permit an offering of the function called by the operator.

That is, when the digital MFP 10 detects that the copy function, the fax transmission function, the scanner function or the printer function has been called (step S107: YES), the digital MFP 10 determines whether or not the offering of the called function is permitted in accordance with the permission setting stored in the RAM 113 (step S108). When the offering of the called function is permitted (step S108: YES), the digital MFP 10 transfers to a standby state in which the called function can be used (step S109). Under the standby state, the digital MFP 10 actually starts a process in response to, for example, an operation of a start button of the operation unit 125.

Unless a logout operation is performed at step S110, the digital MFP 10 returns to step S107, and detects whether or not the copy function, the fax transmission function, the scanner function or the printer function has been called.

When the digital MFP 10 does not detect that the copy function, the fax transmission function, the scanner function or the printer function has been called (step S107: NO), or when the offering of the called function is not permitted according to the referenced permission setting (step S108: NO), the digital MFP 10 does not transfer to the standby state in which the called function can be used.

After the user ID and the password are successfully authenticated in the processing system 1, the digital MFP 10 is not required to acquire the authentication result from the authentication server 30 each time when the copy function, the fax transmission function, the scanner function or the printer function is called by the digital MFP 10. Therefore, communication data volume between the digital MFP 10 and the authentication server 30 can be reduced, and a processing load of the authentication server 30 can be reduced.

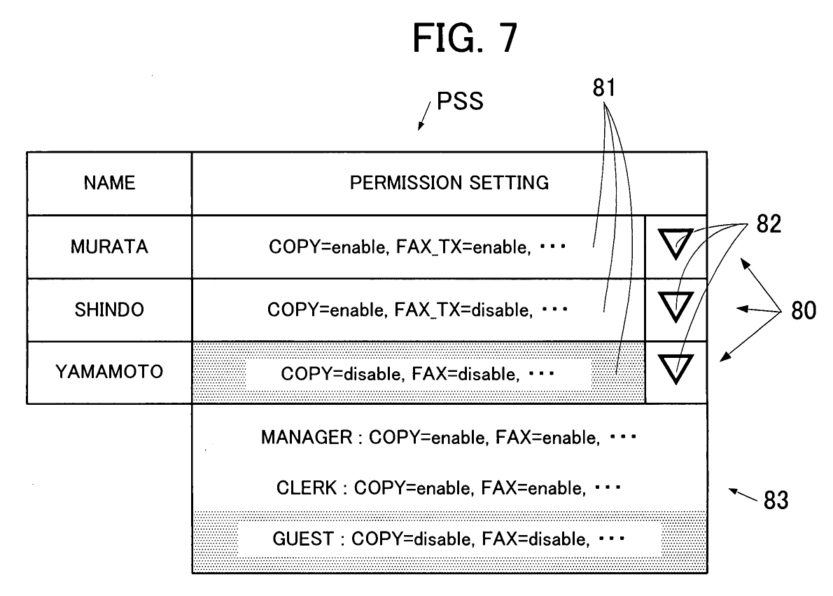

(5. Editing of permission setting) FIG. 7 illustrates a permission setting editing screen PSS used for editing the permission setting of the record information RI.

As illustrated in FIG. 7, the permission setting editing screen PSS displays a list of a name of operators assigned with a user ID and a password which an authentication is permitted.

Combo boxes 80 are arranged to the right of each of the names listed in the permission setting editing screen PSS. Further, the combo boxes 80 are arranged for setting whether or not to permit an offering of the function to the operators corresponding to the displayed names. The operator can directly enter the permission setting to rectangular regions 81 of the combo boxes 80. The operator can press buttons 82 arranged to the right of the rectangular regions 81, and display a list 83 of choices of the previously registered permission setting. The operator can reference the displayed choices and select a desired permission setting. Further, a name for an identification purpose (for example, “MANAGER”, “CLERK” and “GUEST”) is assigned to the choices of the permission setting to be referenced by the operator.

The permission setting can easily be edited in the authentication server 30 from such a permission setting editing screen PSS.

(6. Other preferred embodiments) In the above-described preferred embodiment, when a function is called by an operation performed on the function switching key of the operation unit 125, a determination is carried out as to whether or not to permit to offer the called function. However, the present invention may adopt other preferred embodiments. For example, immediately after receiving the permission setting from the authentication server 30, the digital MFP 10 may determine whether or not to permit the offering for all of the functions. Then, the display unit 126 may display only a software key for calling a function which has been determined that offering of such a function is permitted.

In the above-described preferred embodiment, a function to be permitted to be offered is differed for each operator by the digital MFP 10. However, as another example, a function to be permitted to be offered may be differed for each operator by the client computer 20, which controls the digital MFP 10. That is, a function offered by a printer driver and a scanner driver (hereinafter collectively referred to as a “driver”) installed for controlling the digital MFP 10 may be differed for each operator by the client computer 20.

In this case, when the driver is started or when a control command and/or data for the digital MFP 10 is issued, the client computer 20 requests the operator to enter a user ID and a password, and acquires an authentication result with respect to the entered user ID and the password from the authentication server 30. When the authentication succeeds, the client computer 20 uses the above-described option process to receive a permission setting from the authentication server 30. Further, the permission setting is information relating to whether or not to permit an offering of a function of the driver to the operator.

After the client computer 20 acquires such a permission setting, the client computer 20 can refer to the acquired permission setting to determine whether or not the function called by the operator thereafter is permitted to be offered.

Further, an example of functions, which a determination is carried out as to whether or not an offering of such a function is permitted, includes a scan instruction, a print instruction, a setting change, and an editing of stored information.

While the present invention has been described with respect to preferred embodiments thereof, it will be apparent to those skilled in the art that the disclosed invention may be modified in numerous ways and may assume many embodiments other than those specifically set out and described above. Accordingly, the appended claims are intended to cover all modifications of the present invention that fall within the true spirit and scope of the present invention.

What is claimed is:

1. A processing device comprising:
an authentication acquiring means for transmitting authentication information acquired from an operator to a remote authentication server, and receiving an authentication result with respect to the transmitted authentication information from the remote authentication server;
a permission setting receiving means for receiving a permission setting from the remote authentication server, wherein the permission setting is information associated with the successfully authenticated authentication information and relates to whether or not to permit to offer a function;
means for storing the received permission setting; and
means for determining whether or not to permit to offer the function after authentication has succeeded in accordance with the permission setting stored in the means for storing.

2. The processing device according to claim 1, wherein after the authentication acquiring means receives the authentication result indicating that the authentication has succeeded, the permission setting receiving means transmits a search request of permission setting associated with the successfully authenticated authentication information to the authentication server, and receives the permission setting from the authentication server as a response to the transmitted search request.

3. The processing device according to claim 1, wherein when the operator calls a function, the authentication acquiring means transmits the authentication information to the remote authentication server, and receives an authentication result with respect to the transmitted authentication information from the remote authentication server.

4. The processing device according to claim 1, further comprising:
a display unit arranged to display a software key; and
a display control means for controlling a content of the software key displayed on the display unit,
wherein the display control means determines whether or not to permit an offering for all functions immediately after receiving the permission setting from the remote authentication server, and displays only the software key for calling a function which has been determined that offering of such a function is permitted.

5. The processing device according to claim 1, wherein the authentication information is a user ID and a password entered by the operator during a login operation.

6. The processing device according to claim 1, wherein the function includes a part of or all of a copy function, a fax function, a scanner function and a printer function.

7. The processing device according to claim 1, wherein the function includes a part of or all of a scan instruction, a print instruction, a setting change and an editing of stored information.

8. An authentication server comprising:
a storing means for associating authentication information with a permission setting, which is information relating to whether or not to permit to offer a function after authentication has succeeded in a remote processing device, and storing the associated authentication information and the permission setting;
an authentication offering means for receiving the authentication information from the remote processing device and transmitting an authentication result with respect to the received authentication information to the processing device; and
a permission setting transmitting means for transmitting a permission setting associated with the successfully authenticated authentication information to the processing device in connection with the transmission of the authentication result.

9. The authentication server according to claim 8, wherein the permission setting associated with the authentication information can be selected from previously registered choices.

10. The authentication server according to claim 9, wherein a name for identification can be assigned to the choices, and the assigned name can be referenced when making a selection from the choices.

11. The authentication server according to claim 8, wherein after the authentication offering means transmits the authentication result indicating that the authentication has succeeded to the processing device, when the permission setting transmitting means receives a search request of the permission setting from the remote processing device, the permission setting transmitting means transmits the permission setting associated with the successfully authenticated authentication information to the remote processing device in response to the received search request.

12. The authentication server according to claim 8, wherein the authentication information is a user ID and a password.

13. The authentication server according to claim 8, wherein the function includes a part of or all of a copy function, a fax function, a scanner function and a printer function.

14. The authentication server according to claim 8, wherein the function includes a part of or all of a scan instruction, a print instruction, a setting change and an editing of stored information.

15. A processing system comprising:
a processing device which offers a function called by an operator; and
an authentication server,
wherein the processing device includes:
an authentication acquiring means for transmitting authentication information acquired from the operator to the authentication server, and receiving an authentication result with respect to the transmitted authentication information from the authentication server,
a permission setting receiving means for receiving a permission setting from the authentication server, wherein the permission setting is information associated with the successfully authenticated authentication information and relates to whether or not to permit to offer a function,
means for storing the received permission setting, and
means for determining whether or not to permit to offer the function after authentication has succeeded in accordance with the permission setting stored in the means for storing, and
wherein the authentication server includes:
a storing means for associating and storing the authentication information and the permission setting,
an authentication offering means for receiving the authentication information from the processing device and transmitting an authentication result with respect to the received authentication information to the processing device, and
a permission setting transmitting means for transmitting the permission setting associated with the received authentication information to the processing device in connection with the transmission of the authentication result.

16. The processing system according to claim 15, wherein after the authentication acquiring means receives the authentication result indicating that the authentication has succeeded, the permission setting receiving means transmits a search request of the permission setting associated with the successfully authenticated authentication information to the authentication server, and receives the permission setting from the authentication server as a response to the search request.

17. The processing system according to claim 15, wherein the authentication server can select the permission setting associated with the authentication information from previously registered choices.

18. The processing system according to claim 16, wherein a name for identification can be assigned to the choices, and the assigned name can be referenced when making a selection from the choices.

19. The processing system according to claim 15, wherein after the authentication offering means transmits the authentication result indicating that the authentication has succeeded to the processing device, when the permission setting transmitting means receives a search request of the permission setting from the processing device, the permission setting transmitting means transmits the permission setting associated with the successfully authenticated authentication information to the processing device in response to the received search request.

20. A function offering method in a processing system comprising a processing device and an authentication server, the function offering method comprising:
an associating and storing step of associating authentication information with a permission setting and storing the associated authentication information and the permission setting in the authentication server;
an authentication information transmitting step of transmitting authentication information acquired from an operator from the processing device to the authentication server;
an authentication executing step of executing authentication of the authentication information transmitted at the authentication information transmitting step in accordance with an association relation stored at the associating and storing step in the authentication server;
an authentication result transmitting step of transmitting an authentication result from the authentication server to the processing device after executing the authentication at the authentication executing step;
a permission setting transmitting step of transmitting a permission setting, which is information associated with the successfully authenticated authentication information and relates to whether or not to permit to offer a function, from the authentication server to the processing device after the authentication result indicating that authentication has succeeded is transmitted at the authentication result transmitting step;
a storing step of storing the permission setting transmitted at the permission setting transmitting step in the processing device; and
a determining step of determining whether or not to permit to offer the function after the authentication has succeeded in accordance with the permission setting stored at the storing step in the processing device.
